(19) United States
(12) Patent Application Publication
(10) Pub. No.: US 2008/0269461 A1
(43) Pub. Date: Oct. 30, 2008

(54) Polymeric Carbazole Compounds

(75) Inventors: Albert Van Dijken, Eindhoven (NL); Klemens Brunner, Eindhoven (NL); Bea Maria Wilhelmina Langeveld-Voss, Eindhoven (NL); Harmannus Franciscus Maria Schoo, Eindhoven (NL); Jolanda Johanna Anna Maria Bastiaansen, Eindhoven (NL); Nicole Maria Matthias Kiggen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,118

(22) PCT Filed: Nov. 22, 2006
(86) PCT No.: PCT/IB2006/054377

§ 371 Date: Jun. 19, 2008

(30) Foreign Application Priority Data
Dec. 20, 2005 (EP) 05112480.8

(51) Int. Cl. C08G 73/06

(52) U.S. Cl. 528/423

(57) ABSTRACT

A polymeric carbazole compound comprising a monomer unit of formula (I): is disclosed, wherein x and y are equal to zero or 1, and n is an integer equal to or larger than zero. P represents a phenyl group, and C¹, C² and C³ represent carbazole units. The derealization of the triplet wave function over the biphenyl structure is decreased by introducing twists in the polymer backbone at the location where the two carbazole units are connected, whereby the triplet energy is increased. The twist is introduced by substituents, e.g. methoxy or 3,7-dimethyloctyloxy. The polymeric carbazole compound may be used as a semiconducting material. The semiconducting material may be used as a host matrix for luminescent emitters.

### FIELD OF THE INVENTION

The present invention relates to polymeric carbazole compounds, a semi conducting material comprising such polymeric carbazole compounds, and electro luminescent devices comprising such a semi conducting material. The semi conducting material may be combined with a luminescent emitter.

The invention also relates to a process for the preparation of such polymeric carbazole compounds, as well as to the use of such compounds as a semi conducting material. The semi conducting material may be used as a host matrix for luminescent emitters.

### BACKGROUND OF THE INVENTION

In Organic Light Emitting Diodes (OLEDs), the efficiency of the conversion of current into light depends on the recombination efficiency of electrons and holes, and on the luminescence quantum efficiency of the light-emitting compound. In state-of-the-art devices, the recombination efficiency is close to unity, i.e. nearly all injected charge carriers recombine in the device. The excited state generated by such a recombination can be either a singlet or a triplet state. The terms singlet and triplet denote the mutual orientation of the charge carriers' spin moment.

At room temperature, the majority of organic materials, both small molecules and polymers, only emit light from the lowest excited singlet state. This process is called fluorescence. Only few molecules emit light from the lowest excited triplet state. This process is called phosphorescence. Therefore, in conventional OLEDs the emission is due to fluorescence of the excited molecules.

According to quantum spin statistics, 25% of the recombinations of an electron and a hole result in the formation of singlet excited states, while 75% yield triplet excited states. Consequently, for conventional OLEDs the internal quantum efficiency is limited to 25%. This means that 75% of the power applied to a conventional OLED device is not used to generate light. This is an unacceptably high percentage of wasted energy, especially if mobile applications are considered.

An elegant way to use all excited states formed in an OLED for the generation of light is the introduction of phosphorescent emitters (also named triplet emitters or phosphorescent metal complexes) in the emissive layer (Baldo, M. A. et al. Nature 1998, 395, 151). These emitters have the ability to harvest both triplet and singlet excitations formed in the emissive layer, thereby using all excited states for the emission of light. As a result, the device efficiency is considerably increased.

A type of compound that can be used as a phosphorescent emitter is a heavy-metal complex. Due to the presence of a heavy-metal atom, the excited state of such a complex is of mixed singlet-triplet character (due to the so-called heavy-atom effect). In principle, any excited state of such a heavy-metal complex can emit light (of course, not every excited state will emit light as there is always a probability for an excited state to decay non-radiatively). An excited state can either be formed directly on the heavy-metal complex (by sequential trapping of electrons and holes) or it can be formed via energy transfer from an excited state of the host. Energy transfer (either via a dipole-dipole mechanism of via an exchange mechanism) of both singlet and triplet excited states of the host to the heavy-metal complex is allowed.

The phosphorescent emitters are usually dispersed in a host compound. The host compound (consisting of either small molecules or polymers) serves as a matrix to make a solid-state solution of the phosphorescent emitter. The host compound is usually a (semi-)conducting material so that it can serve to transport charge carriers.

High-efficiency OLEDs based on small molecules (smOLEDs) make use of phosphorescent emitters dispersed in a host material, and the combination of host and phosphorescent emitter is applied as a layer in a multi-layer structure by vacuum evaporation. Such systems are well known for smOLEDs but much less for OLEDs based on (conjugated) polymers (pLEDs).

The main problem that opposes a widespread use of phosphorescent emitters in pLEDs is the scarcity of suitable host polymers, especially for high-energy (i.e. green and blue) phosphorescent emitters.

The host compound for phosphorescent emitters has to fulfil the important condition that the triplet energy of the host has to be higher than that of the phosphorescent emitter. In order to provide efficient phosphorescence from the phosphorescent emitter, the lowest excited triplet state of the host has to be higher in energy than the lowest emitting state of the phosphorescent emitter (see FIG. 1). This requirement arises because energy will always reside on the lowest excited state of a system. Since emission from the phosphorescent emitter is desired, the lowest excited state has to be on the phosphorescent emitter and not on the host compound.

In FIG. 1, the singlet ground state is denoted by S₀. The energies of all excited state levels are shown relative to that of the ground state. For the polymer host, only the lowest excited singlet (S₁) and triplet (T₁^{host}) levels are shown. For the phosphorescent emitter, a manifold of excited triplet levels is shown, the lowest being indicated by T₁^{guest}. The solid arrows indicate radiative processes, while the dashed arrows indicate non-radiative processes. The horizontal dashed arrows indicate energy transfer processes. In this particular situation, excited state energy can be transferred from the polymer to the phosphorescent emitter, but not vice versa. If the lowest excited state of the phosphorescent emitter has an energy lower than that of the lowest excited state of the host polymer, the phosphorescent emitter can harvest both singlet and triplet excitations from the host polymer, thereby increasing the efficiency of an organic light-emitting diode to 100%.

Compounds based on carbazole as host materials for polymer OLEDs are known from WO2004/055129. The energy of the lowest excited triplet state of these carbazole derivatives is just high enough to accommodate a red or green phosphorescent emitter. The compounds from this class of carbazole-based (co)polymers have triplet energies up to 2.6 eV. Obviously, for most applications a blue color is needed. Therefore, host polymers with triplet energies higher than 2.6 eV are required. To be able to host blue phosphorescent emitters the triplet energy of the host polymer should be at least 2.725 eV. That opens the applicability of the host to phosphorescent emitters emitting blue light of 455 nm (2.725 eV).

Thus, there is a continuing need for new host polymer materials for high-energy (i.e. blue) phosphorescent emitters.

### SUMMARY OF THE INVENTION

It is an object of the present invention to fulfil the need for improved host polymer materials for high-energy phosphorescent emitters. This object is achieved by a polymeric carbazole compound comprising monomer units of formula (I):

—(C¹)—(C²)ₓ—(C³)_{y}—(P)ₘ— (I)

wherein
x and y are equal to zero or 1,
n is an integer equal to or larger than zero,
C¹ is a compound of the following formula (II):

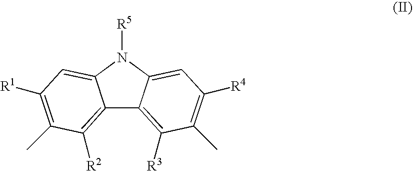

C² is a compound of the following formula (II):

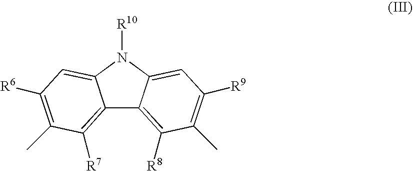

C³ is a compound of the following formula (IV):

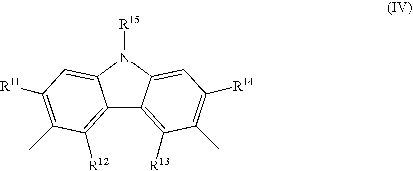

P is a compound of the following formula (V):

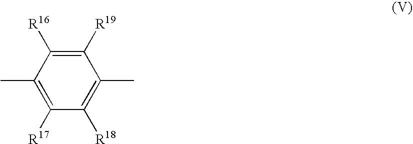

wherein

R¹, R², R³, R⁴, R⁶, R⁷, R⁸, R⁹, R¹¹, R¹², R¹³, R¹⁴, R¹⁶, R¹⁷, R¹⁸ and R¹⁹ may be H or a substituent selected from the group consisting of —OR⁴¹, —OR⁴², —SR⁴¹, —SR⁴², —NR⁴¹R⁴⁵ and —NR⁴²R⁴⁵;

R⁵, R¹⁰, and R¹⁵ are the same or different at each occurrence and may be selected from R⁴¹ and R⁴²;

with

R⁴¹ being C₁-C₂₀ cyclic or acyclic straight or branched chain alkyl, optionally interrupted one or more times with —O—, —OC(═O)—, —C(═O)O—, —S—, secondary nitrogen, tertiary nitrogen, quaternary nitrogen, —CR⁴⁵═CR⁴⁶—, —C≡C—, —C(═O)—, —C(═O)NR⁴⁵—, —NR⁴⁵C(═O)—, —S(═O)—, —S(═O)₂—, or —X⁶—, and/or substituted one or more times with R⁴², R⁵⁷, or R⁵⁸;

R⁴² being C₅-C₃₀ aryl in which, optionally, one or more of the aromatic carbon atoms are replaced with N, O or S, and, optionally, one or more of the aromatic carbon atoms carry a group R⁴¹, R⁵⁷, or R⁵⁸;

R⁵⁷ being —CN, —CF₃, —CSN, —NH₂, —NO₂, —NCO, —NCS, —OH, —F, —PO₂, —PH₂, —SH, —Cl, —Br, or —I;

R⁵⁸ being —C(═O)R⁴⁵, —C(═O)OR⁴⁵, —C(═O)NR⁴⁵R⁴⁶, —NHR⁴⁵, —NR⁴⁵R⁴⁶, —N⁽⁺)R⁴⁵R⁴⁶R⁴⁷, —NC(═O)R⁴⁵—, —OR⁴⁵, —OC(═O)R⁴⁵, —SR⁴⁵, —S(═O)R⁴⁵, or —S(═O)₂R⁴⁵;

R⁴⁵, R⁴⁶, and R⁴⁷ being, the same or different at each occurrence, H, R⁴¹, R⁴²;

X⁶ being C₄-C₃₀ arylene in which, optionally, one or more of the aromatic carbon atoms are replaced with N, O, or S, and, optionally, one or more of the aromatic carbon atoms carry a group R⁴¹, R⁵⁷, or R⁵⁸;

wherein
when x is zero, y is zero, and n≧1:

at least one of [R³, R⁴, R¹⁶, and R¹⁷] and at least one of [R¹⁶, R¹⁷, R¹⁸, and R¹⁹] is one of said substituents;

when x is zero, y is 1, and n is zero:

at least one of [R³, R⁴, R¹¹, and R¹²] is one of said substituents;

when x is zero, y is 1, and n≧1:

at least one of [R³, R⁴, R¹¹, and R¹²] and at least one of [R¹³, R¹⁴, R¹⁶, and R¹⁷]

and at least one of [R¹⁶, R¹⁷, R¹⁸, and R¹⁹] is one of said substituents;

when x is 1, y is zero, and n is zero:

at least one of [R³, R⁴, R⁶, and R⁷] is one of said substituents;

when x is 1, y is zero, and n≧1:

at least one of [R³, R⁴, R⁶, and R⁷] and at least one of [R⁸, R⁹, R¹⁶, and R¹⁷]

and at least one of [R¹⁶, R¹⁷, R¹⁸, and R¹⁹] is one of said substituents;

when x is 1, y is 1, and n is zero:

at least one of [R³, R⁴, R⁶, and R⁷] and at least one of [R⁸, R⁹, R¹¹, and R¹²] is one of said substituents; and

when x is 1, y is 1, and n≧1:

at least one of [R³, R⁴, R⁶, and R⁷] and at least one of [R⁸, R⁹, R¹¹, and R¹²]

and at least one of [R¹³, R¹⁴, R¹⁶, and R¹⁷] and at least one of [R¹⁶, R¹⁷, R¹⁸, and R¹⁹] is one of said substituents.

In particular:

when x is zero, y is zero, and n≧1:

at least one of [R³, R⁴], and at least one of [R¹⁶, R¹⁷] is one of said substituents;

when x is zero, y is 1, and n is zero:

at least one of [R³, R⁴], and at least one of [R¹¹, R¹²] is one of said substituents;

when x is zero, y is 1, and n≧1:

at least one of [R³, R⁴], and at least one of [R¹¹, R¹²], and at least one of [R¹³, R¹⁴], and at least one of [R¹⁶, R¹⁷] is one of said substituents;

when x is 1, y is zero, and n is zero:

at least one of [R³, R⁴], and at least one of [R⁶, R⁷] is one of said substituents;

when x is 1, y is zero, and n≧1:

at least one of [R³, R⁴], and at least one of [R⁶, R⁷], and at least one of [R¹⁶, R¹⁷], and at least one of [R¹⁸, R¹⁹] is one of said substituents;

when x is 1, y is 1, and n is zero:

at least one of [R³, R⁴], and at least one of [R¹¹, R¹²], and at least one of [R⁶, R⁷, R⁸, R⁹] is one of said substituents; and

when x is 1, y is 1, and n≧1:

at least one of [R³, R⁴], and at least one of [R⁶, R⁷], and at least one of [R⁸, R⁹], and at least one of [R¹¹, R¹²], and at least one of [R¹³, R¹⁴], and at least one of [R¹⁶, R¹⁷] is one of said substituents.

By the introduction of substituents in these particular positions, twists are introduced in the polymer backbone at the location where two units (either carbazole or phenyl) are connected. Thereby, the delocalization of the triplet wave function is decreased, and the triplet energy is increased. Therefore, these compounds are excellent to function as host polymer materials for high-energy (i.e. blue) phosphorescent emitters.

In a preferred polymeric carbazole compound according to the invention, x is 1; y is zero; n is 1, each of R¹, R², R³, R⁷, R⁸, R⁹, R¹⁷, and R¹⁹ is H, each of R⁴, R⁶, R¹⁶ and R¹⁸ is —OR⁴¹, and each of R⁵ and R¹⁰ is R⁴¹ (corresponds to NK938, see below).

In another preferred polymeric carbazole compound according to the invention, x is 1; y is 1; n is zero; each of R², R³, R⁶, R⁷, R⁸, R², R³, R⁴ is H; each of R¹, R⁴, R⁹, R¹, is —OR⁴¹, and each of R⁵, R¹⁰ and R¹⁵ is R⁴¹ (corresponds to NK921, see below).

In another preferred polymeric carbazole compound according to the invention, x is 1; y is 1;

n is zero; each of R¹, R², R³, R⁷, R⁸, R⁹, R¹², R¹³, is H; each of R⁴, R⁶, R¹¹, and R¹⁴ is —OR⁴¹, and each of R⁵, R¹⁰ and R¹⁵ is R⁴¹ (corresponds to NK957, see below).

—OR⁴¹ may for example be methoxy (—OCH₃, MeO) or a straight or branched alkoxy chain of formula —OC₁₀H₂₁, e.g. 3,7-dimethyloctyloxy. R⁴¹ may for example be a straight or branched alkyl chain of formula —C₁₀H₂₁, e.g. 3,7-dimethyloctyl.

Preferred polymeric carbazole compounds of the present invention comprise monomer units of the following formulas NK938, NK921 and NK957:

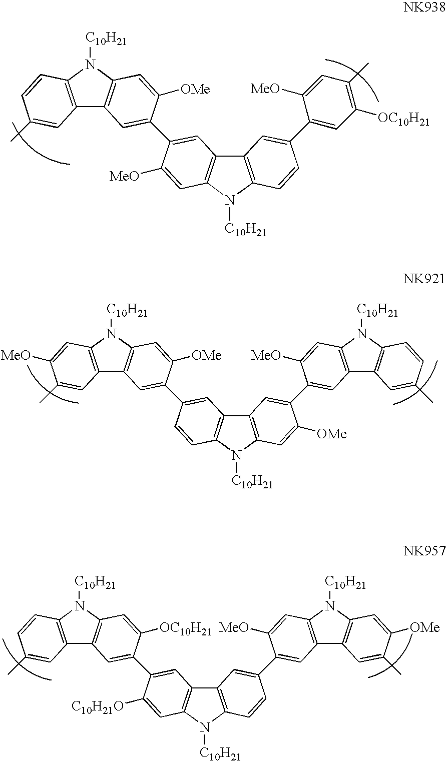

The present invention also relates to a semi conducting material comprising a polymeric carbazole compound as defined above, as well as to an electro luminescent device comprising such a semi conducting material. The semiconducting material may be combined with a luminescent emitter.

Further, the present invention relates to process for the preparation of a polymeric carbazole compound as defined above, and to the use of such polymeric carbazole compounds a semiconducting material. In particular, the above described polymeric carbazole compounds are suitable to be used as a host matrix for luminescent emitters.

### BRIEF DESCRIPTION OF THE DRAWINGS

FIG. 1 shows the energy level scheme of a polymer host and a phosphorescent emitter.

FIG. 2 shows the phosphorescence spectra at 77 K of the polymers NK921 (dashed line) and NK351 (solid line). The position of the lowest excited triplet level is indicated by a dashed line.

FIG. 3 shows the normalized electro luminescence spectrum of a host polymer according to the invention, NK957, in which a blue phosphorescent emitter (ADS065BE) is dispersed.

FIG. 4 shows the electro luminescence efficiency as function of the voltage for a blue phosphorescent emitter dispersed in carbazoles host polymers according to the invention, NK921 [denoted “twisted polymer (method 1)”] and NK938 [denoted “twisted polymer (method 2)”], and in prior art carbazole host polymers [denoted “non-twisted polymer”], respectively.

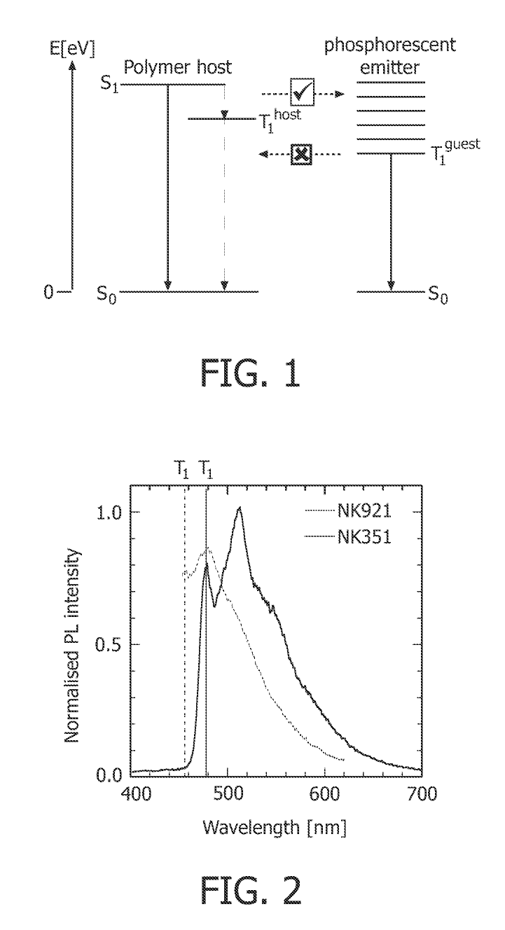

### DESCRIPTION OF PREFERRED EMBODIMENTS

In the research work leading to the present invention, the inventors very unexpectedly found a new group of carbazole polymers suitable for hosting blue phosphorescent emitters. Such carbazole polymers comprise monomer units of formula (I):

—(C¹)—(C²)ₓ—(C³)_{y}—(P)ₙ— (I)

wherein x and y are equal to zero or 1, and n is an integer equal to or larger than zero. P represents a phenyl group, and C¹, C² and C³ represent carbazole units. The delocalization of the triplet wave function over the biphenyl structure is decreased by introducing twists in the polymer backbone at the location where the two carbazole units are connected, whereby the triplet energy is increased. The twist is introduced by substituents, e.g. methoxy or 3,7-dimethyloctyloxy. The polymeric carbazole compound may be used as a semiconducting material. The semiconducting material may be used as a host matrix for luminescent emitters.

As described above, to prevent the host polymer from acting as a phosphorescence quencher, the polymer is required to have a triplet energy that exceeds that of the phosphorescent emitter. For a red phosphorescent emitter, this can be readily achieved but it is very difficult to achieve for green and particularly for blue phosphorescent emitters. Thus, the key point of the invention is the provision of polymers having the ability to combine a large triplet energy gap with a suitable charge transport level.

To be able to increase the triplet energy of the host compounds one has to look at the localization of the triplet wave function on the basic building blocks of the carbazole polymers. Generally, the more delocalized the triplet wave function is, the lower the triplet energy will be. So the strategy will be to localize the triplet wave function on a small part of the basic building blocks of the carbazole polymers.

Insight into the problem can be gained by looking at polyphenyl molecules. The triplet energy of polyphenyl molecules decreases as the number of phenyl groups increases. From benzene to biphenyl to p-terphenyl, the triplet energy decreases from 3.65 eV to 2.84 eV to 2.55 eV respectively. However, from biphenyl to m-terphenyl, the triplet energy hardly changes (2.84 eV for biphenyl, and 2.81 eV for m-terphenyl) (Birks, J. B. Photophysics of aromatic compounds; John Wiley & Sons: New York, 1970).

TABLE 1
Triplet energies (T₁) of various polyphenyl molecules

| | | T₁ |
|---|---|---|
| name | structure | [eV] |
| benzene | 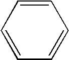 | 3.65 |
| biphenyl | 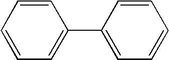 | 2.84 |
| p-terphenyl | 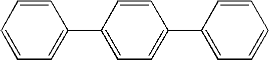 | 2.55 |
| m-terphenyl | 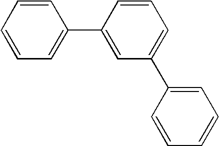 | 2.81 |

This is in accordance with studies on polyphenyl molecules that have shown that for poly(p-phenyl) molecules the conjugated system is delocalized along the longest molecular axis, and that for m-polyphenyl molecules the triplet state is localized at every composing biphenyl structure (Higuchi, J. et al. J. Phys. Chem. A 2001, 105, 6084; and Higuchi, J. et al. J. Phys. Chem. A 2002, 106, 8609).

In this respect it is interesting to note that the triplet energies of fluorene and carbazole (2.95 eV and 3.05 eV respectively) are higher than that of biphenyl. However, for[3,3′]-bicarbazolyl, the basic building block for the above described carbazole derivatives, the triplet energy (2.75 eV) has decreased to a value close to that of biphenyl (see table 2).

TABLE 2
Triplet energies (T₁) of fluorene, carbazole, and [3,3′]-bicarbazolyl

| | | T₁ |
|---|---|---|
| name | structure | [eV] |
| fluorene | 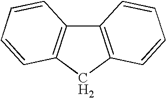 | 2.95 |
| carbazole | 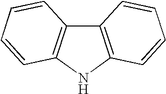 | 3.05 |
| [3,3′]-bicar-bazolyl | 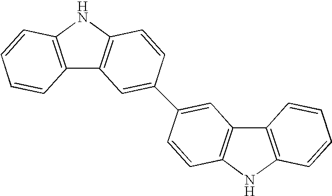 | 2.75 |

This indicates not only that in [3,3′]-bicarbazolyl the triplet exciton is more delocalized than in carbazole, but also that the triplet exciton is predominantly delocalized over the biphenyl structure that is shared between the two carbazole units. This explains why the triplet energy changes from a monomer to a dimer, but remains constant from a dimer to a trimer (Brunner, K. et al. J. Am. Chem. Soc. 2004, 126, 6035; and van Dijken, A. et al. J. Am. Chem. Soc. 2004, 126, 7718).

The chemical structure of the basic building block of the carbazole derivatives: [3,3′]-bicarbazolyl, is shown below. The approximate localization of the triplet wave function is indicated with a dashed line.

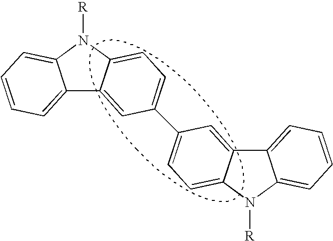

To increase the triplet energy, the delocalization of the triplet wave function over the biphenyl structure has to be decreased. According to the present invention, this is done by introducing twists in the polymer backbone at the location where the two carbazole units are connected.

Polymeric carbazole compounds according to the present invention comprise monomer units of formula (I):

—(C¹)—(C²)ₓ—(C³)_{y}—(P)ₙ— (I)

wherein

x and y are equal to zero or 1,

n is an integer equal to or larger than zero,

C¹ is a compound of the following formula (II):

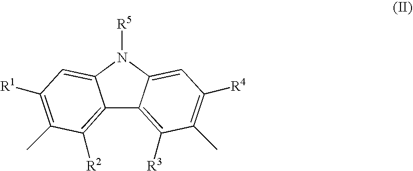

C² is a compound of the following formula (III):

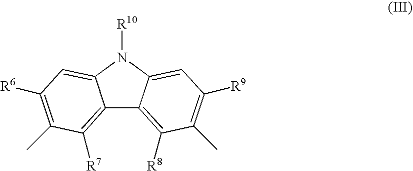

C³ is a compound of the following formula (IV):

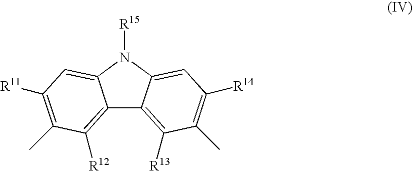

P is a compound of the following formula (V):

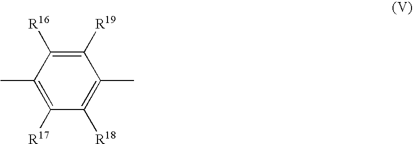

wherein R¹, R², R³, R⁴, R⁶, R⁷, R⁸, R⁹, R¹¹, R¹², R¹³, R¹⁴, R¹⁶, R¹⁷, R¹⁸ and R¹⁹ may be H or twist inducing substituents.

It is to be understood that any combination of substitutions leading to the desired triplet energy increase is within the scope of the present invention.

The introduction of substituents on the carbazole moieties, as suggested according to the present invention, induces a twist between two adjacent carbazole moieties due to sterical hindrance. As a result of this twist, the amount of conjugation, and consequently the amount of delocalization of the triplet excited state, decreases. This leads to an increase of the triplet energy of the polymer (in other words, the triplet energy of the polymer approaches that of an individual carbazole moiety).

For a polymer LED, the ionization potential of the polymer should preferably be smaller than the work function of the anode. In this situation there will be no barrier for the injection of a hole from the anode into the polymer, when the device is forward biased. When constructing an energy level scheme, this requirement means that the HOMO level of the polymer should preferably be situated at a less negative energy than the Fermi level of the anode (the energies of such levels are always drawn at negative values with respect to zero, which is the vacuum level).

The use of substituents to increase the triplet energy of a carbazole-based polymer should not result in a shift of the HOMO level of that same polymer to such an extent that holes cannot be injected anymore from the anode. On the other hand, this does not necessarily mean that the use of substituents should not influence the HOMO level at all. The important point here is the energy difference between the Fermi level of the anode (work function) and the HOMO level of the polymer (ionization potential).

In the research work leading to the present invention, the inventors surprisingly found that certain substitutents do not influence the position of the HOMO level, while other substituents, e.g. alkyl groups, shift the HOMO level to a more negative value. In particular, the following groups could be used as twist-inducing substituents according to the present invention:

—OR⁴¹, —OR⁴², —SR⁴¹, —SR⁴², —NR⁴¹R⁴⁵, or —NR⁴²R⁴⁵; with

R⁴¹ being C₁-C₂₀ cyclic or acyclic straight or branched chain alkyl, optionally interrupted one or more times with —O—, —OC(═O)—, —C(═O)O—, —S—, secondary nitrogen, tertiary nitrogen, quaternary nitrogen, —CR⁴⁵═CR⁴⁶—, —C≡C—, —C(═O)—, —C(═O)NR⁴⁵—, —NR⁴⁵C(═O)—, —S(═O)—, —S(═O)₂—, or —X⁶—, and/or substituted one or more times with R⁴², R⁵⁷, or R⁵⁸;

R⁴² being C₅-C₃₀ aryl in which, optionally, one or more of the aromatic carbon atoms are replaced with N, O or S, and, optionally, one or more of the aromatic carbon atoms carry a group R⁴¹, R⁵⁷, or R⁵⁸;

R⁵⁷ being —CN, —CF₃, —CSN, —NH₂, —NO₂, —NCO, —NCS, —OH, —F, —PO₂, —PH₂, —SH, —Cl, —Br, or —I;

R⁵⁸ being —C(═O)R⁴⁵, —C(═O)OR⁴⁵, —C(═O)NR⁴⁵R⁴⁶, —NHR⁴⁵, —NR⁴⁵R⁴⁶, —N⁽⁺⁾R⁴⁵R⁴⁶R⁴⁷, —NC(═O)R⁴⁵—, —OR⁴⁵, —OC(═O)R⁴⁵, —SR⁴⁵, —S(═O)R⁴⁵, or —S(═O)₂R⁴⁵;

R⁴⁵, R⁴⁶, and R⁴⁷ being, the same or different at each occurrence, H, R⁴¹, or R⁴²;

X⁶ being C₄-C₃₀ arylene in which, optionally, one or more of the aromatic carbon atoms are replaced with N, O, or S, and, optionally, one or more of the aromatic carbon atoms carry a group R⁴¹, R⁵⁷, or R⁵⁸.

—OR⁴¹ groups, i.e. alkoxy groups, in particular methoxy and/or 3,7-dimethyloctyloxy, are preferred as twist-inducing substituents.

In the formulas C¹, C² and C³, R⁵, R¹⁰, and R¹⁵ may be the same or different at each occurrence and may be selected from R⁴¹ and R⁴² as defined above.

Preferred polymeric carbazole compounds of the present invention comprise monomer units of the following formulas NK938, NK921 and NK957:

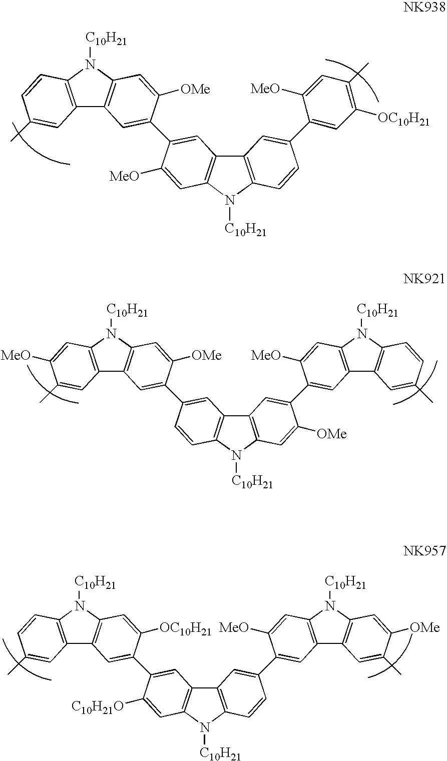

As is clear from the claims and the specification as a whole, there should be no conjugation within monomer (I), and also no conjugation between monomer (I) and its neighboring monomers in the polymer chain.

Although the examples disclosed in the present application discloses polymers comprising monomers of formula (I) only, it is to be understood that the polymeric carbazole compounds according to the invention could also contain other monomers. When such other monomers are conjugated compounds themselves, the conjugation between these monomers and monomer (I) should be interrupted by inducing a twist between them. In practice, such other conjugated monomers will be connected to monomer (I) via a phenyl ring. This phenyl ring might be part of any conjugated compound. In that case, at least one of the substituents at each end of monomer (I) (R¹ or R² at one end, and, depending on the values of x, y, and n, R³ or R⁴, R⁸ or R⁹, R¹³ or R¹⁴, R¹⁸ or R¹⁹ at the other end) should be a twist-inducing substituent.

The polymeric carbazole compounds according to the present invention are very well suited for use as host material for any luminescent emitter, i.e. both phosphorescent emitters and fluorescent emitters. In particular, it is suited for use as a host material for phosphorescent emitters.

The present invention can be realized in any application that is based on organic electro luminescent materials, in particular in lighting applications (e.g. Large-Area Lighting Systems).

### EXAMPLES

In the examples 1 and 2 below, two specific ways to introduce the desired twists in the polymer backbone are described. It is to be understood that the specific twist inducing substituents disclosed in these examples, i.e. methoxy and 3,7-dimethyloctyloxy, could be substituted for any other twist inducing side substituents, as defined above. In particular, any other twist inducing alkoxy groups may be used. Further, the number and location of the twist inducing substituents is not limited to the examples shown.

### Example 1

### Twist-Inducing Substituents

The principle is illustrated by comparing the two polymers NK351 and NK921 that both have the same carbazole-based backbone in which the carbazole units are connected via the [3,3′] positions. The only difference between these two polymers is that NK921 has methoxy units (OMe) at some of the [2,2′] positions. These groups twist the two carbazole units with respect to each other so that the wave function overlap is decreased.

As a result of this twist, the triplet energy is increased from 2.56 eV for NK351 to 2.73 eV for NK921 (see Table 3). These values can be seen as lower limit and are recorded on films in the solid state at 77 K. Furthermore, the half-wave oxidation potential does not increase considerably as a result of introducing this particular twist in the polymer backbone. This means the triplet energy is increased without shifting the HOMO level, which is to be used for charge injection. All oxidations are reversible.

FIG. 2 shows the phosphorescence spectra at 77 K of the polymers NK921 (dashed line) and NK351 (solid line). The position of the lowest excited triplet level is indicated by a dashed line.

TABLE 3
Chemical structures, triplet energies (T₁), and half-wave
oxidation potentials (E_{1/2}^{ox}) of NK351 and NK921

| | | T₁ | E_{1/2}^{ox} |
|---|---|---|---|
| Code | Structure | [eV] | [V] |
| NK351 | 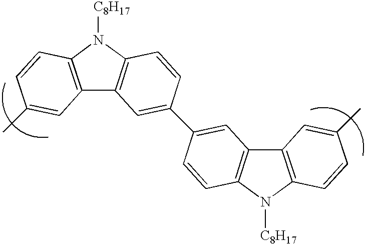 | 2.56 | 0.55 |
| NK921 | 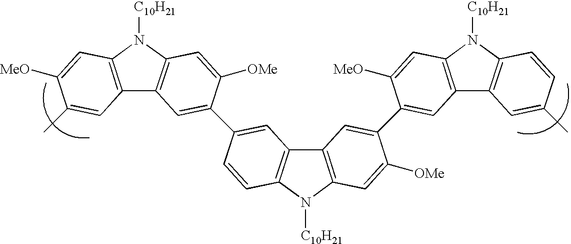 | 2.73 | 0.65 |

### Example 2

### Twist-Inducing Molecule Incorporated into the Main Chain

The carbazole main chain can also be twisted by incorporating into the main chain a molecule that induces a twist. This principle is illustrated below.

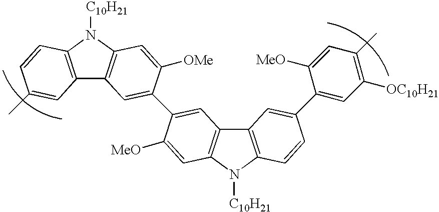

Chemical structure of NK938

An alkoxy-substituted phenyl is inserted between two subsequent [3,3′]-bicarbazolyl units. This approach leads to the same result with respect to the triplet energy as the previous approach but has certain advantages with respect to the preparation. The [3,3′]-bicarbazolyl is prepared before the polymerization and represents the monomer of the carbazole main chain polymer. These monomers are now linked via the alkoxy-substituted phenyl groups, which is synthetically easier than linking the [3,3′]-bicarbazolyl directly.

### Result

The increase in triplet energy can immediately be seen in the electro luminescence efficiency of blue devices. The device contains a host polymer (the carbazole polymers described herein and a non-twisted polymer described in WO2004/055129) in which the blue phosphorescent emitter ADS065BE (American Dye Source, Inc.) is dispersed at a mass ratio of 20%. This layer is sandwiched between an ITO/PEDOT:PSS anode and a TPBI/LiF/Al cathode. The efficiencies increase up to a factor of four to eight compared to untwisted host polymers by introducing a twist in the polymer backbone either via the first or the second method without increasing the onset voltage of light emission (FIG. 4).

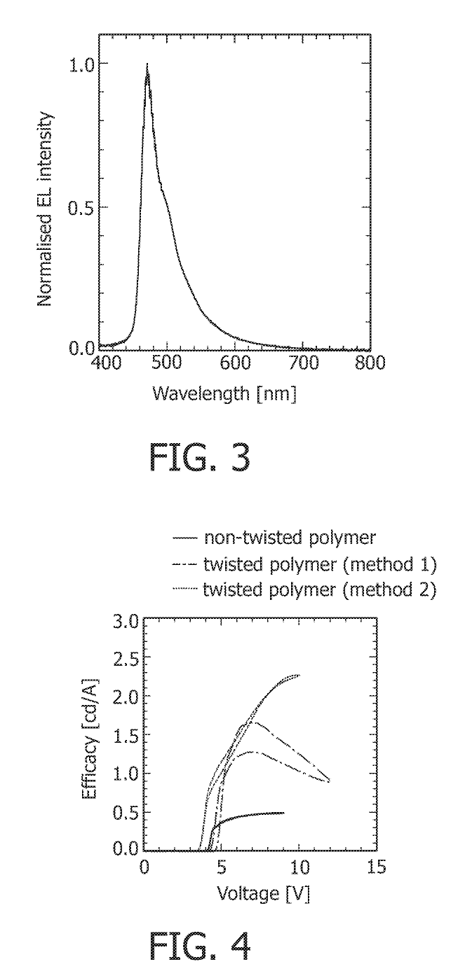

FIG. 3 shows the normalized electro luminescence spectrum of NK957 in which the blue phosphorescent emitter ADS065BE (American Dye Source, Inc.) is dispersed at a mass ratio of 20%. The device architecture is ITO/PEDOT:PSS (200 nm)/NK957+ADS065BE (80 nm)/TPBI (30 nm)/LiF (5 nm)/Al (100 nm).

### Experimental

The half-wave oxidation potentials were determined with cyclic voltammetry (CV) measurements. CV measurements were recorded in dichloromethane, with 1 M tetrabutylammonium hexafluorophosphate as supporting electrolyte. The working electrode was a platinum disc (0.2 cm²), the counter electrode was a platinum plate (0.5 cm²), and a saturated Ag/AgCl electrode was used as reference electrode, calibrated against a Fc/Fc⁺ couple. The triplet levels where determined with phosphorescence measurements. The emission spectra were recorded at 77 K with an Edinburgh 900 spectrofluorometer. Non-gated and gated spectra were recorded to discriminate the phosphorescence from fluorescence. The gate delay was 500 μs with a gate width of 9 ms. the highest energy peak in the phosphorescence spectrum was taken for the S₀^{v=0}←T₁^{v=0} transition. Some carbazole-based host polymers with a twisted backbone are summarized in Table 4.

TABLE 4
Overview of some carbazole-based host polymers with a twisted backbone

| Code | Structure |
|---|---|
| NK938 | 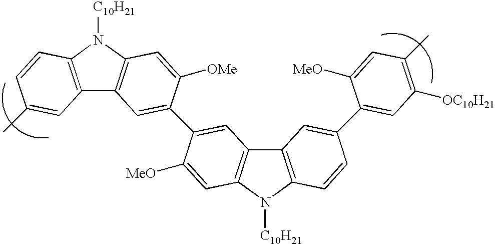 |
| NK921 | 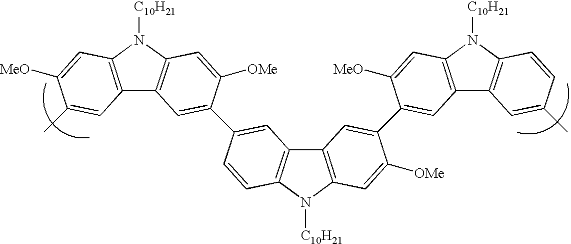 |
| NK957 | 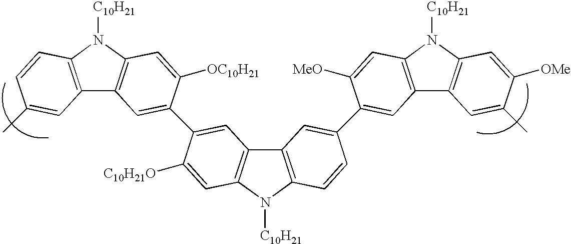 |

### Synthesis Protocols

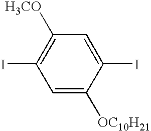

### Referential Example 1

### 2,5-diiodo-4-(3,7-dimethyloctyloxy)anisole

A mixture of 25.0 g (95 mmol) 4-(3,7-dimethyloctyloxy)anisole, 28 g (111 mmol) iodine and 8.2 g (38 mmol) KIO₃ in 500 ml acetic acid, 40 ml water and 10 ml conc. H₂SO₄ was charged with argon and heated at reflux temperature during 16 hours. The mixture was allowed to cool to room temperature. The product was extracted using water/diethylether and saturated Na₂CO₃ (aq.)/diethylether, respectively. The organic layers were dried (MgSO₄), filtered and concentrated. After column chromatography (SiO₂, hexane/dichloromethane, 90/10, v/v) 34 g (70%) of product was obtained.

¹H NMR (CDCl₃): δ 7.23 (s, 1H), 7.22 (s, 1H), 4.0 (t, J=6.5 Hz, 2H), 3.83 (s, 3H), 1.93-1.15 (m, 10H), 0.98 (d, J=6.5 Hz, 3H), 0.90 (d, J=6.5 Hz, 6H).

¹³C NMR (CDCl₃): δ 153, 153, 123, 121, 86, 85, 69, 57, 39, 37, 36, 30, 28, 25, 23, 23, 20.

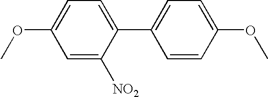

### Referential Example 2

### 4,4′-dimethoxy-2-nitro-1,1′-biphenyl

A flask containing a mixture of 14.9 g (64 mmol) 4-bromo-3-nitroanisole, 18 g (77 mmol) 4-(4,4,5,5-tetramethyl-1,3,2-dioxaborolyl)anisole, 70 ml toluene and 70 ml 2 M potassium carbonate (aq) was evacuated and charged with argon for three times, after which 2 mol % Pd(PPh₃)₄ was added. Evacuation and filling with argon was repeated once and the mixture was stirred for 60 hours at reflux temperature. The mixture was allowed to cool to room temperature, the organic layer was separated, dried (MgSO₄), filtered and concentrated. After column chromatography (SiO₂, hexane/dichloromethane, 50/50, v/v) 12.0 g (72%) of product was obtained.

¹H NMR (CDCl₃): δ 7.33 (s, J=1.5 Hz, 1H), 7.32 (d, J=8 Hz, 1H), 7.20 (d, J=8 Hz, 2H), 7.12 (dd, J=1.5 Hz, J=8 Hz, 1H), 6.93 (d, J=8 Hz, 2H), 3.88 (s, 3H), 3.83 (s, 3H).

¹³C NMR (CDCl₃): δ 159, 159, 149, 132, 129, 129, 128, 119, 114, 109, 56, 55.

mp: 138° C.

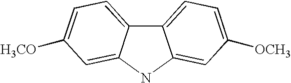

### Referential Example 3

### 2,7-dimethoxycarbazole

10 g (38.6 mmol) 4,4′-dimethoxy-2-nitro-1,1′-biphenyl in 35 ml triethylphosphite is refluxed during 16 hours. The mixture was allowed to cool to room temperature, upon which the product precipitates. Filtration gave 6.5 g (74%) of a white solid.

¹H NMR (DMSO-d₆): δ 11.00 (s, 1H), 7.85 (d, J=8 Hz, 2H), 6.94 (d, J=1.5 Hz, 2H), 6.74 (dd, J=1.5 Hz, J=8 Hz, 2H), 3.82 (s, 6H).

¹³C NMR (DMSO-d₆): δ 157, 141, 119, 116, 107, 94, 55.

mp: 285° C.

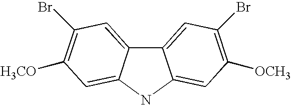

### Referential Example 4

### 3,6-dibromo-2,7-dimethoxycarbazole

In a flask, covered with aluminum foil, a stirred solution of 1.48 g (6.5 mmol) 2,7-dimethoxycarbazole in 60 ml tetrahydrofuran was cooled to 0° C. 2.3 g (13 mmol) N-bromosuccinimide was added in small portions. The mixture was allowed to warm to room temperature overnight. The THF was evaporated and the product was used without further purification.

¹H NMR (DMSO-d₆): δ 11.30 (s, 1H), 8.30 (s, 2H), 7.13 (s, 2H), 3.90 (s, 6H).

¹³C NMR (DMSO-d₆): δ 153, 140, 123, 116, 102, 94, 56.

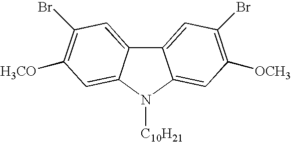

### Referential Example 5

### 3,6-dibromo-9-(3,7-dimethyloctyl)-2,7-dimethoxycarbazole

To a stirred solution of 2.5 g (6.5 mmol) 3,6-dibromo-2,7-dimethoxycarbazole and 40 mg benzyltriethylammoniumchloride in 10 ml toluene was added drop wise 3.8 g 50 w % NaOH (aq). Afterwards 1.7 g (7.7 mmol) 3,7-dimethyloctylbromide was added drop wise. After complete addition the reaction mixture was heated to reflux during 16 hours. The organic layer was separated, washed with saturated Na₂CO₃ (aq), dried over MgSO₄, filtered and concentrated. After column chromatography (SiO₂, hexane/dichloromethane/Et₃N, 80/20/1, v/v/v), followed by crystallization (dichloromethane/ethanol) 2.1 g (61%) of a white solid was obtained.

¹H NMR (CDCl₃): δ 8.10 (s, 2H), 6.84 (s, 2H), 4.26 (t, J=8 Hz, 2H), 4.03 (s, 6H), 1.98-1.150 (m, 10H), 1.07 (d, J=6.5 Hz, 3H), 0.88 (d, J=6.5 Hz, 6H).

¹³C NMR (CDCl₃): δ 154, 140, 124, 117, 103, 92, 56, 41, 39, 37, 35, 31, 28, 25, 23, 23, 20.

mp: 113° C.

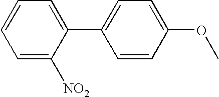

### Referential Example 6

### 4′-methoxy-2-nitro-1,1′-biphenyl

A flask containing a mixture of 10.7 g (53 mmol) 1-bromo-2-nitrobenzene, 14.9 g (64 mmol) 4-(4,4,5,5-tetramethyl-1,3,2-dioxaborolyl)anisole, 70 ml toluene and 70 ml 2 M potassium carbonate (aq) was evacuated and charged with argon for three times, after which 2 mol % Pd(PPh₃)₄ was added. Evacuation and filling with argon was repeated once and the mixture was stirred for 48 hours at reflux temperature. The mixture was allowed to cool to room temperature, the organic layer was separated, dried (MgSO₄), filtered and concentrated. After column chromatography (SiO₂, hexane/dichloromethane, 60/40, v/v) 8.5 g (70%) of product was obtained.

¹H NMR (CDCl₃): δ 7.84 (dd, J=1.5 Hz, J=8 Hz, 1H), 7.62 (dt, J=1.5 Hz, J=8 Hz, 1H), 7.48 (dd, J=1.5 Hz, J=8 Hz, 1H), 7.46 (dt, J=1.5 Hz, J=8 Hz, 1H), 7.29 (d, J=8 Hz, 2H), 7.00 (d, J=8 Hz, 2H), 3.82 (s, 3H).

¹³C NMR (CDCl₃): δ 159, 136, 132, 132, 129, 129, 128, 124, 114, 55.

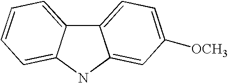

### Referential Example 7

### 2-methoxycarbazole

8.36 g (36.7 mmol) 4′-methoxy-2-nitro-1,1′-biphenyl in 40 ml triethylphosphite is refluxed during 16 hours. The mixture was allowed to cool to room temperature, upon which the product precipitates. Filtration gave 6.67 g (93%) of a white solid.

¹H NMR (DMSO-d₆): δ 11.10 (s, 1H), 8.00 (dd, J=1.5 Hz, J=8 Hz, 1H), 7.8 (d, J=8 Hz, 1H), 7.44 (dd, J=1.5 Hz, J=8 Hz, 1H), 7.30 (dt, J=1.5 Hz, J=8 Hz, 1H), 7.12 (dt, J=1.5 Hz, J=8 Hz, 1H), 6.98 (d, J=1.5 Hz, 1H), 6.78 (dd, J=1.5 Hz, J=8 Hz, 1H), 3.83 (s, 3H).

¹³C NMR (DMSO-d₆): δ 158, 141, 140, 124, 123, 121, 119, 118, 116, 111, 108, 94, 55.

mp: 239° C.

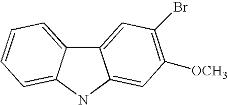

### Referential Example 8

### 3-bromo-2-methoxycarbazole

In a flask, covered with aluminum foil, a stirred solution of 6.62 g (33.6 mmol) 2-methoxycarbazole in 150 ml tetrahydrofuran was cooled to 0° C. 5.38 g (30.2 mmol) N-bromosuccinimide was added in small portions. The mixture was allowed to warm to room temperature overnight. The THF was evaporated and the product was used without further purification.

¹H NMR (DMSO-d₆): δ 11.30 (s, 1H), 8.34 (s, 1H), 8.04 (dd, J=1.5 Hz, J=8 Hz, 1H), 7.46 (dd, J=1.5 Hz, J=8 Hz, 1H), 7.33 (dt, J=1.5 Hz, J=8 Hz, 1H), 7.14 (dt, J=1.5 Hz, J=8 Hz, 1H), 7.14 (s, 1H), 3.93 (s, 3H).

¹³C NMR (DMSO-d₆): δ 153, 140, 139, 124, 124, 122, 120, 119, 116, 110, 101, 95, 56.

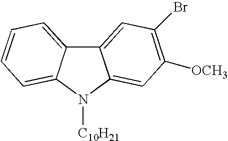

### Referential Example 9

### 3-bromo-9-(3,7-dimethyloctyl)-2-methoxycarbazole

To a stirred solution of 7.16 g (26 mmol) 3-bromo-2-methoxycarbazole and 0.17 g benzyltriethylammoniumchloride in 25 ml toluene was added drop wise 15 g 50 w % NaOH (aq). Afterwards 6.9 g (31 mmol) 3,7-dimethyloctylbromide was added drop wise. After complete addition the reaction mixture was heated to reflux during 16 hours. The organic layer was separated, washed with water, dried over MgSO₄, filtered and concentrated. 9.3 g (76%) of a product was obtained after column chromatography (SiO₂, hexane/dichloromethane, 80/20, v/v).

¹H NMR (CDCl₃): δ 8.24 (s, 1H), 8.00 (dd, J=1.5 Hz, J=8 Hz, 1H), 7.42 (dt, J=1.5 Hz, J=8 Hz, 1H), 7.38 (dd, J=1.5 Hz, J=8 Hz, 1H), 7.24 (dt, J=1.5 Hz, J=8 Hz, 1H), 6.88 (s, 1H), 4.27 (t, J=8 Hz, 2H), 4.03 (s, 3H), 1.98-1.10 (m, 10H), 1.05 (d, J=6.5 Hz, 3H), 0.88 (d, J=6.5 Hz, 6H).

¹³C NMR (CDCl₃): 154, 140, 140, 125, 125, 122, 120, 119, 118, 109, 103, 92, 56, 41, 39, 37, 35, 31, 25, 23, 23, 20.

mp: 55° C.

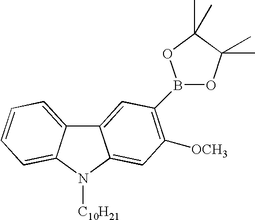

### Referential Example 10

### 9-(3,7-dimethyloctyl)-2-methoxy-3-(4,4,5,5-tetramethyl-1,3,2-dioxaborolyl)carbazole

A solution of 5.6 g (13 mmol) 3-bromo-9-(3,7-dimethyloctyl)-2-methoxycarbazole in 75 ml tetrahydrofuran was cooled to −78° C. 7 ml (18 mmol) 2.5 M n-butyllithium was added dropwise. After 1 hour 3.4 ml (16 mmol) 2-isopropoxy-4,4,5,5-tetramethyl-1,3,2-dioxaborolane was added dropwise. The reaction mixture was allowed to warm to room temperature overnight. The THF was evaporated and the product was purified by extraction with diethylether and water. The organic layer was dried (MgSO₄), filtered and concentrated. 5.9 g (95%) of product was used without further purification.

¹H NMR (CDCl₃): δ 8.46 (s, 1H), 8.06 (dd, J=1.5 Hz, J=8 Hz, 1H), 7.38 (dt, J=1.5 Hz, J=8 Hz, 1H), 7.37 (dd, J=1.5 Hz, J=8 Hz, 1H), 7.24 (dt, J=1.5 Hz, J=8 Hz, 1H), 6.80 (s, 1H), 4.27 (t, J=8 Hz, 2H), 3.95 (s, 3H), 1.95-1.10 (m, 10H), 1.40 (s, 12H), 1.05 (d, J=6.5 Hz, 3H), 0.88 (d, J=6.5 Hz, 6H).

¹³C NMR (CDCl₃): 164, 144, 140, 130, 124, 123, 120, 119, 116, 108, 91, 83, 56, 41, 39, 37, 35, 31, 31, 28, 25, 24, 22, 22, 20, 14.

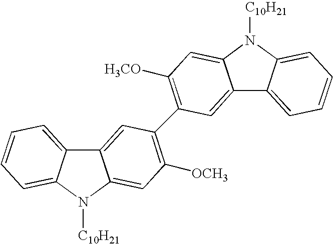

### Referential Example 11

### 9,9′-bis(3,7-dimethyloctyl)-2,2′-dimethoxy-3,3′-bicarbazolyl

A flask containing a mixture of 2.7 g (6.5 mmol) 3-bromo-9-(3,7-dimethyloctyl)-2-methoxycarbazole, 3.0 g (6.5 mmol) 9-(3,7-dimethyloctyl)-2-methoxy-3-(4,4,5,5-tetramethyl-1,3,2-dioxaborolyl)carbazole, 10 ml toluene and 10 ml 2 M potassium carbonate (aq) was evacuated and charged with argon for three times, after which 2 mol % Pd(PPh₃)₄ was added. Evacuation and filling with argon was repeated once and the mixture was stirred for 20 hours at reflux temperature. The mixture was allowed to cool to room temperature, the organic layer was separated, dried (MgSO₄), filtered and concentrated. After column chromatography (SiO₂, hexane/dichloromethane, 70/30, v/v) and crystallization (ethanol) 1.9 g (44%) of product was obtained.

¹H NMR (CDCl₃): δ 8.05 (s, 2H), 8.03 (dd, J=1.5 Hz, J=8 Hz, 2H), 7.43 (dt, J=1.5 Hz, J=8 Hz, 2H), 7.42 (dd, J=1.5 Hz, J=8 Hz, 2H), 7.23 (dt, J=1.5 Hz, J=8 Hz, 2H), 6.95 (s, 2H), 4.37 (t, J=8 Hz, 4H), 3.95 (s, 6H), 2.03-1.15 (m, 20H), 1.07 (d, J=6.5 Hz, 6H), 0.88 (d, J=6.5 Hz, 12H).

¹³CNMR (CDCl₃): δ 157, 141, 140, 124, 123, 121, 120, 119, 116, 108, 91, 56, 41, 39, 37, 36, 31, 28, 25, 23, 23, 20.

mp: 139° C.

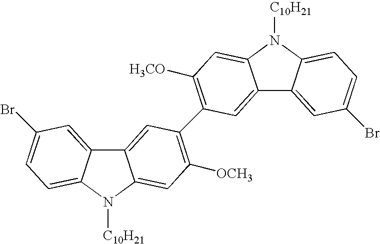

### Referential Example 12

### 6,6′-dibromo-9,9′-bis(3,7-dimethyloctyl)-2,2′-dimethoxy-3,3′-bicarbazolyl

In a flask, covered with aluminum foil, a stirred solution of 0.5 g (0.74 mmol) 9,9′-bis(3,7-dimethyloctyl)-2,2′-dimethoxy)-3,3′-bicarbazolyl in 5 ml tetrahydrofuran was cooled to 0° C. 0.25 g (1.4 mmol) N-bromosuccinimide was added in small portions. The mixture was allowed to warm to room temperature overnight. The THF was evaporated. After extraction with dichloromethane and saturated Na₂CO₃ (aq) 0.57 g (98%) of product was obtained. This was used without further purification.

¹H NMR (CDCl₃): δ 8.10 (d, J=1.5 Hz, 2H), 7.96 (s, 2H), 7.49 (dd, J=1.5 Hz, J=8 Hz, 2H), 7.25 (d, J=8 Hz, 2H), 6.94 (s, 2H), 4.30 (t, J=8 Hz, 4H), 3.95 (s, 6H), 2.00-1.15 (m, 20H), 1.10 (d, J=6.5 Hz, 6H), 0.88 (d, J=6.5 Hz, 12H).

¹³C NMR (CDCl₃): δ 158, 141, 139, 127, 125, 123, 122, 121, 115, 112, 110, 91, 56, 41, 39, 37, 35, 31, 28, 25, 23, 23, 20.

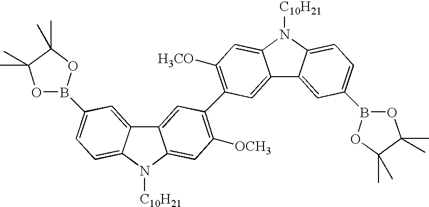

### Referential Example 13

### 6,6′-bis(4,4,5,5-tetramethyl-1,3,2-dioxaborolyl)-9,9′-bis(3,7-dimethyloctyl)-2,2′-dimethoxy-3,3′-bicarbazolyl

A solution of 5.62 g (6.8 mmol) 6,6′-dibromo-9,9′-bis(3,7-dimethyloctyl)-2,2′-dimethoxy-3,3′-bicarbazolyl in 40 ml tetrahydrofuran was cooled to −78° C. 6.2 ml (15.5 mmol) 2.5 M n-butyllithium was added dropwise. After 1 hour 3.0 ml (15 mmol) 2-isopropoxy-4,4,5,5-tetramethyl-1,3,2-dioxaborolane was added dropwise. The reaction mixture was allowed to warm to room temperature overnight. The THF was evaporated and the product was purified by extraction with diethylether and water. The organic layer was dried (MgSO₄), filtered and concentrated. After several crystallizations from dichloromethane/ethanol 3.8 g (61%) product was obtained as a white solid.

¹H NMR (CDCl₃): δ 8.54 (d, J=1.5 Hz, 2H), 8.10 (s, 2H), 7.88 (dd, J=1.5 Hz, J=8 Hz, 2H), 7.38 (d, J=8 Hz, 2H), 6.97 (s, 2H), 4.32 (t, J=8 Hz, 4H), 3.94 (s, 6H), 2.02-1.00 (m, 20H), 1.38 (s, 24H), 1.10 (d, J=6.5 Hz, 6H), 0.88 (d, J=6.5 Hz, 12H).

¹³C NMR (CDCl₃): δ 157, 143, 141, 131, 127, 124, 123, 121, 116, 108, 91, 83, 56, 41, 39, 37, 36, 31, 28, 25, 25, 23, 20.

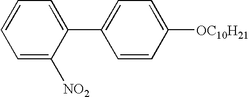

### Referential Example 14

### 4′-(3,7-dimethyloctyloxy)-2-nitro-1,1′-biphenyl

A flask containing a mixture of 11.2 g (55 mmol) 1-bromo-2-nitrobenzene, 23.9 g (66 mmol) 1-(3,7-dimethyloctyloxy)-4-(4,4,5,5-tetramethyl-1,3,2-dioxaborolyl)benzene, 60 ml toluene and 60 ml 2 M potassium carbonate (aq) was evacuated and charged with argon for three times, after which 2 mol % Pd(PPh₃)₄ was added. Evacuation and filling with argon was repeated once and the mixture was stirred for 60 hours at reflux temperature. The mixture was allowed to cool to room temperature and water was added. The organic layer was separated, dried (MgSO₄), filtered and concentrated. After column chromatography (SiO₂, hexane/dichloromethane, 80/20, v/v) 12.9 g (66%) of product was obtained.

¹H NMR (CDCl₃): δ 7.80 (dd, J=1.5 Hz, J=8 Hz, 1H), 7.58 (dt, J=1.5 Hz, J=8 Hz, 1H), 7.44 (dd, J=1.5 Hz, J=8 Hz, 1H), 7.43 (dt, J=1.5 Hz, J=8 Hz, 1H), 7.25 (d, J=8 Hz, 2H), 6.96 (d, J=8 Hz, 2H), 4.02 (t, J=8 Hz, 2H), 1.90-1.13 (m, 10H), 0.97 (d, J=6.5 Hz, 3H), 0.88 (d, J=6.5 Hz, 6H),

¹³C NMR (CDCl₃): δ 159, 136, 132, 132, 129, 129, 128, 124, 115, 66, 39, 37, 36, 30, 28, 25, 23, 23, 20.

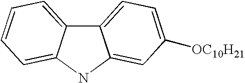

### Referential Example 15

### 2-(3,7-dimethyloctyloxy)carbazole

13 g (36.6 mmol) 4′-(3,7-dimethyloctyloxy)-2-nitro-1,1′-biphenyl in 33 ml triethylphosphite is refluxed during 16 hours. The mixture was allowed to cool to room temperature. After evaporation of the triethylphosphite 10.5 g (89%) of product was obtained as a white solid.

¹H NMR (DMSO-d₆): δ 11.0 (s, 1H), 7.95 (d, J=8 Hz, 1H), 7.92 (d, J=8 Hz, 1H), 7.39 (d, J=8 Hz, 1H), 7.25 (t, J=8 Hz, 1H), 7.17 (t, J=8 Hz, 1H), 6.93 (d, J=1.5 Hz, 1H), 6.73 (dd, J=1.5 Hz, J=8 Hz, 1H), 4.02 (t, J=8 Hz, 2H), 1.80-1.10 (m, 10H), 0.92 (d, J=6.5 Hz, 3H), 0.82 (d, J=6.5 Hz, 6H).

¹³C NMR (DMSO-d₆): δ 158, 141, 140, 124, 123, 121, 119, 118, 116, 111, 108, 95, 66, 39, 37, 36, 29, 27, 24, 23, 23, 20.

mp: 188° C.

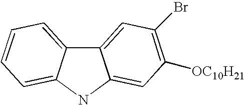

### Referential Example 16

### 3-bromo-2-(3,7-dimethyloctyloxy)carbazole

In a flask, covered with aluminum foil, a stirred solution of 10.5 g (32.5 mmol) 2-(3,7-dimethyloctyloxy)carbazole in 40 ml tetrahydrofuran was cooled to 0° C. 5.20 g (29.2 mmol) N-bromosuccinimide was added is small portions. The mixture was allowed to warm to room temperature overnight. The THF was evaporated and the product was used without further purification.

¹H NMR (DMSO-d₆): δ 11.20 (s, 1H), 8.33 (s, 1H), 8.05 (dd, J=1.5 Hz, J=8 Hz, 1H), 7.46 (dd, J=1.5 Hz, J=8 Hz, 1H), 7.33 (dt, J=1.5 Hz, J=8 Hz, 1H), 7.14 (dt, J=1.5 Hz, J=8 Hz, 1H), 7.14 (s, 1H), 4.15 (t, J=8 Hz, 2H), 1.95-1.10 (m, 10H), 0.98 (d, J=6.5 Hz, 3H), 0.83 (d, J=6.5 Hz, 6H).

¹³C NMR (DMSO-d₆): 153, 140, 140, 125, 122, 120, 119, 117, 111, 111, 102, 96, 67, 39, 37, 36, 29, 27, 24, 23, 23, 20.

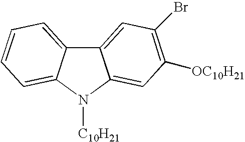

### Referential Example 17

### 3-bromo-9-(3,7-dimethyloctyl)-2-(3,7-dimethyloctyloxy)carbazole

To a stirred solution of 13 g (32.3 mmol) 3-bromo-2-(3,7-dimethyloctyloxy)carbazole and 0.2 g benzyltriethylammoniumchloride in 35 ml toluene was added dropwise 20 g 50 w % NaOH (aq). Afterwards 8.6 g (38.9 mmol) 3,7-dimethyloctylbromide was added dropwise. After complete addition the reaction mixture was heated to reflux during 60 hours. The organic layer was separated, washed with water, dried over MgSO₄, filtered and concentrated. 10.1 g (57%) of a pale yellow oil was obtained after column chromatography (SiO₂, hexane/dichloromethane, 80/20, v/v).

¹H NMR (CDCl₃): δ 8.23 (s, 1H), 7.99 (dd, J=1.5 Hz, J=8 Hz, 1H), 7.41 (dt, J=1.5 Hz, J=8 Hz, 1H), 7.38 (dd, J=1.5 Hz, J=8 Hz, 1H), 7.23 (dt, J=1.5 Hz, J=8 Hz, 1H), 6.87 (s, 1H), 4.30-4.12 (m, 4H), 2.07-1.10 (m, 20H), 1.07 (d, J=6.5 Hz, 3H), 1.03 (d, J=6.5 Hz, 3H), 0.92 (d, J=6.5 Hz, 6H), 0.88 (d, J=6.5 Hz, 6H).

¹³C NMR (CDCl₃): δ 154, 140, 140, 125, 124, 122, 120, 119, 117, 108, 103, 93, 67, 41, 39, 37, 37, 36, 35, 31, 30, 28, 28, 26, 25, 25, 23, 23, 20.

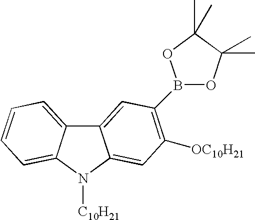

### Referential Example 18

### 9-(3,7-dimethyloctyl)-2-(3,7-dimethyloctyloxy)-3-(4,4,5,5-tetramethyl-1,3,2-dioxaborolyl) carbazole

A solution of 4.81 g (9 mmol) 3-bromo-9-(3,7-dimethyloctyl)-2-(3,7-dimethyloctyloxy)carbazole in 40 ml tetrahydrofuran was cooled to −78° C. 4.6 ml (11.5 mmol) 2.5 M n-butyllithium was added dropwise. After 1 hour 2.2 ml (10.8 mmol) 2-isopropoxy-4,4,5,5-tetramethyl-1,3,2-dioxaborolane was added dropwise. The reaction mixture was allowed to warm to room temperature overnight.

The THF was evaporated and the product was purified by extraction with diethylether and water. The organic layer was dried (MgSO₄), filtered and concentrated. 3.7 g (70%) product was used without further purification.

¹H NMR (CDCl₃): δ 8.42 (s, 1H), 8.06 (dd, J=1.5 Hz, J=8 Hz, 1H), 7.38 (dt, J=1.5 Hz, J=8 Hz, 1H), 7.37 (dd, J=1.5 Hz, J=8 Hz, 1H), 7.24 (dt, J=1.5 Hz, J=8 Hz, 1H), 6.80 (s, 1H), 4.28 (t, J=8 Hz, 2H), 4.18 (t, J=8 Hz, 2H), 1.98-1.10 (m, 20H), 1.05 (d, J=6.5 Hz, 3H), 1.01 (d, J=6.5 Hz, 3H), 0.98 (d, J=6.5 Hz, 6H), 0.97 (d, J=6.5 Hz, 6H).

¹³C NMR (CDCl₃): δ 163, 144, 140, 129, 124, 123, 120, 119, 116, 108, 92, 83, 67, 41, 39, 37, 37, 36, 35, 31, 30, 28, 28, 26, 25, 25, 23, 23, 20.

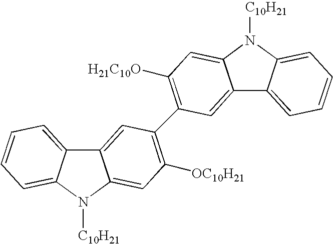

### Referential Example 19

### 9,9′-bis(3,7-dimethyloctyl)-2,2′-bis(3,7-dimethyloctyloxy)-3,3′-bicarbazolyl

A flask containing a mixture of 0.5 g (0.9 mmol) 3-bromo-9-(3,7-dimethyloctyl)-2-(3,7-dimethyloctyloxy)carbazole, 0.65 g (1.1 mmol) 9-(3,7-dimethyloctyl)-2-(3,7-dimethyloctyloxy)-3-(4,4,5,5-tetramethyl-1,3,2-dioxaborolyl)carbazole, 5 ml toluene and 5 ml 2 M potassium carbonate (aq) was evacuated and charged with argon for three times, after which 2 mol % Pd(PPh₃)₄ was added. Evacuation and filling with argon was repeated once and the mixture was stirred for 48 hours at 105° C. The mixture was allowed to cool to room temperature, the organic layer was separated, dried (MgSO₄), filtered and concentrated. After column chromatography (SiO₂, hexane/dichloromethane, 80/20, v/v) 0.55 g (65%) of product was obtained.

¹H NMR (CDCl₃): δ 8.03 (s, 2H), 7.97 (dd, J=1.5 Hz, J=8 Hz, 2H), 7.41-7.36 (m, 4H), 7.21-7.14 (m, 2H), 6.91 (s, 2H), 4.30 (t, J=8 Hz, 4H), 4.07 (t, J=8 Hz, 4H), 1.98-1.00 (m, 40H), 1.10 (d, J=6.5 Hz, 6H), 0.85 (d, J=6.5 Hz, 12H), 0.80 (d, J=6.5 Hz, 6H), 0.78 (d, J=6.5 Hz, 12H).

¹³CNMR (CDCl₃): δ 157, 141, 140, 124, 123, 122, 119, 119, 116, 108, 92, 67, 41, 39, 39, 37, 37, 36, 36, 31, 30, 28, 28, 25, 23, 23, 23, 20, 20.

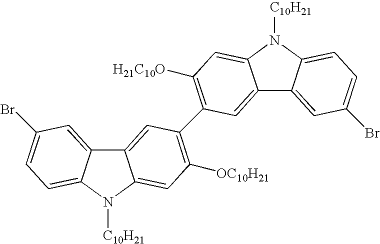

### Referential Example 20

### 6,6′-dibromo-9,9′-bis(3,7-dimethyloctyl)-2,2′-bis(3,7-dimethyloctyloxy)-3,3′-bicarbazolyl

In a flask, covered with aluminum foil, a stirred solution of 0.42 g (0.45 mmol) 9,9′-bis(3,7-dimethyloctyl)-2,2′-bis(3,7-dimethyloctyloxy)-3,3′-bicarbazolyl in 5 ml tetrahydrofuran was cooled to 0° C. 0.15 g (0.84 mmol) N-bromosuccinimide was added in small portions. The mixture was allowed to warm to room temperature overnight. The THF was evaporated. After extraction with dichloromethane and saturated Na₂CO₃ (aq) 0.37 g (75%) of product was obtained.

¹H NMR (CDCl₃): δ 8.07 (d, J=1.5 Hz, 2H), 7.98 (s, 2H), 7.48 (dd, J=1.5 Hz, J=8 Hz, 2H), 7.24 (d, J=8 Hz, 2H), 6.91 (s, 2H), 4.30 (t, J=8 Hz, 4H), 4.08 (t, J=8 Hz, 4H), 1.98-1.00 (m, 40H), 1.10 (d, J=6.5 Hz, 12H), 0.88 (d, J=6.5 Hz, 12H), 0.78 (d, J=6.5 Hz, 12H).

¹³C NMR (CDCl₃): δ 157, 141, 139, 127, 125, 124, 122, 122, 115, 112, 110, 92, 67, 41, 39, 39, 37, 37, 36, 35, 31, 30, 28, 28, 25, 23, 23, 23, 20, 20.

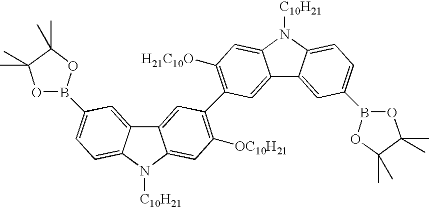

### Referential Example 21

### 6,6′-bis(4,4,5,5-tetramethyl-1,3,2-dioxaborolyl)-9,9′-bis(3,7-dimethyloctyl)-2,2′-bis(3,7-dimethyloctyloxy)-3,3′-bicarbazolyl

A solution of 4.45 g (4 mmol) 6,6′-dibromo-9,9′-bis(3,7-dimethyloctyl)-2,2′-bis(3,7-dimethyloctyloxy)-3,3′-bicarbazolyl in 40 ml tetrahydrofuran was cooled to −78° C. 3.8 ml (11.5 mmol) 2.5 M n-butyllithium was added dropwise. After 1 hour 1.9 ml (9 mmol) 2-isopropoxy-4,4,5,5-tetramethyl-1,3,2-dioxaborolane was added dropwise. The reaction mixture was allowed to warm to room temperature overnight. The THF was evaporated and the product was purified by extraction with diethylether and water. The organic layer was dried (MgSO₄), filtered and concentrated. After several crystallizations from dichloromethane/methanol 2.6 g (54%) product was obtained as a white solid.

¹H NMR (CDCl₃): δ 8.50 (d, J=1.5 Hz, 2H), 8.08 (s, 2H), 7.84 (dd, J=1.5 Hz, J=8 Hz, 2H), 7.36 (d, J=8 Hz, 2H), 6.93 (s, 2H), 4.32 (t, J=8 Hz, 4H), 4.06 (t, J=8 Hz, 4H), 1.98-1.00 (m, 40H), 1.38 (s, 24H), 1.10 (d, J=6.5 Hz, 12H), 0.88 (d, J=6.5 Hz, 12H), 0.83 (d, J=6.5 Hz, 6H), 0.78 (d, J=6.5 Hz, 6H).

¹³C NMR (CDCl₃): δ 157, 143, 141, 131, 127, 124, 123, 122, 116, 108, 93, 83, 41, 39, 39, 37, 37, 36, 35, 31, 30, 28, 28, 25, 25, 23, 23, 23, 20, 20.

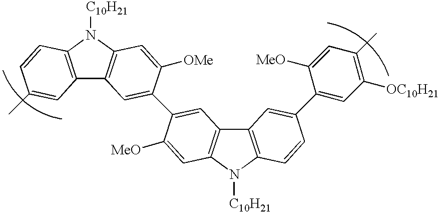

### Example 1 of a Polymeric Carbazole Compound Comprising a Monomer Unit According to the Invention: NK938

A mixture of 0.5 g (0.54 mmol) 6,6′-bis(4,4,5,5-tetramethyl-1,3,2-dioxaborolyl)-9,9′-bis(3,7-dimethyloctyl)-2,2′-dimethoxy-3,3′-bicarbazolyl and 0.28 g (0.54 mmol) 2,5-diiodo-4-(3,7-dimethyloctyloxy)anisole in 25 ml toluene was allowed to stir at room temperature till complete dissolution. Upon deaeration and blanketing with argon, 2 mol % of tetrakis(triphenylphosphine)palladium(0) was added, after which 1.7 ml 20 wt % aqueous tetraethylammonium hydroxide was added. The mixture was allowed to reflux during 20 hours. Then 1.0 mmol of 4,4,5,5-tetramethyl-1,3,2-dioxaborolylbenzene (end capping reagent) and some fresh catalyst were added, followed by refluxing for another 16 hours. The reaction mixture was allowed to cool to room temperature. Several washing steps with aqueous sodium cyanide were performed to remove catalyst residues. Afterwards the organic layer was dried and concentrated. The polymer was isolated after several fractionations and precipitations, respectively, using tetrahydrofuran and methanol. Polymer was obtained as white fibers, 40% yield. Size exclusion chromatography indicated a molecular weight of 18 kg/mol, polydispersity 1.8.

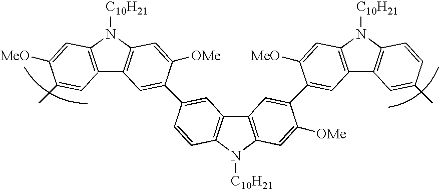

### Example 2 of a Polymeric Carbazole Compound Comprising a Monomer Unit According to the Invention: NK921

A mixture of 0.5 g (0.54 mmol) 6,6′-bis(4,4,5,5-tetramethyl-1,3,2-dioxaborolyl)-9,9′-bis(3,7-dimethyloctyl)-2,2′-dimethoxy-3,3′-bicarbazolyl and 0.28 g (0.54 mmol) 3,6-dibromo-9-(3,7-dimethyloctyl)-2,7-dimethoxycarbazole in 10 ml toluene was allowed to stir at room temperature till complete dissolution. Upon deaeration and blanketing with argon, 2 mol % of tetrakis(triphenylphosphine)palladium(0) was added, after which 1.5 ml 20 wt % aqueous tetraethylammonium hydroxide was added. The mixture was allowed to reflux during 40 hours. Then 1.0 mmol of 4,4,5,5-tetramethyl-1,3,2-dioxaborolylbenzene (end capping reagent) and some fresh catalyst were added, followed by refluxing for another 16 hours. The reaction mixture was allowed to cool to room temperature. Several washing steps with aqueous sodium cyanide were performed to remove catalyst residues. Afterwards the organic layer was dried and concentrated. The polymer was isolated after several fractionations and precipitations, respectively, using tetrahydrofuran and methanol. Polymer was obtained as white fibers, 0.3 g. Size exclusion chromatography indicated a molecular weight of 11 kg/mol, polydispersity 1.5.

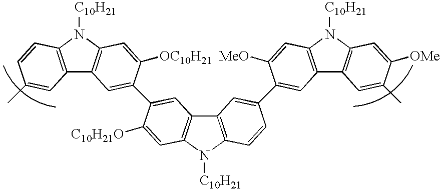

### Example 3 of a Polymeric Carbazole Compound Comprising a Monomer Unit According to the Invention: NK957

A mixture of 1.0 g (0.85 mmol) 6,6′-bis(4,4,5,5-tetramethyl-1,3,2-dioxaborolyl)-9,9′-bis(3,7-dimethyloctyl)-2,2′-bis(3,7-dimethyloctyloxy)-3,3′-bicarbazolyl and 0.45 g (0.85 mmol) 3,6-dibromo-9-(3,7-dimethyloctyl)-2,7-dimethoxycarbazole in 15 ml toluene was allowed to stir at room temperature till complete dissolution. Upon deaeration and blanketing with argon, 2 mol % of tetrakis(triphenylphosphine)palladium(0) was added, after which 2.4 ml 20 wt % aqueous tetraethylammonium hydroxide was added. The mixture was allowed to reflux during 16 hours. Then 1.0 ml of 4,4,5,5-tetramethyl-1,3,2-dioxaborolylbenzene (end capping reagent) and some fresh catalyst were added, followed by refluxing for another 40 hours. The reaction mixture was allowed to cool to room temperature. Several washing steps with aqueous sodium cyanide were performed to remove catalyst residues. Afterwards the organic layer was dried and concentrated. The polymer was isolated after several fractionations and precipitations, respectively, using tetrahydrofuran and methanol. Polymer was obtained as white fibers, 0.68 g. Size exclusion chromatography indicated a molecular weight of 9 kg/mol, polydispersity 1.6.

1. A polymeric carbazole compound comprising a monomer unit of formula (I):
—(C¹)—(C²)ₓ—(C³)_{y}—(P)ₙ— (I)
wherein
x and y are equal to zero or 1,
n is an integer equal to or larger than zero,
C¹ is a compound of the following formula (II): 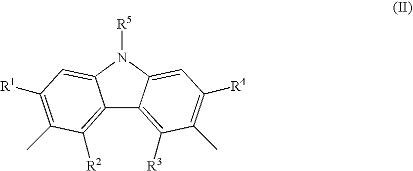
C² is a compound of the following formula (III): 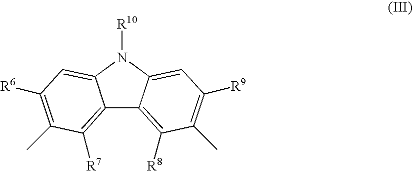
C³ is a compound of the following formula (IV): 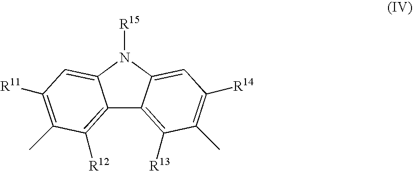
P is a compound of the following formula (V): 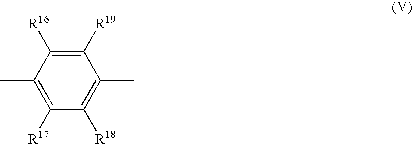
wherein
R¹, R³, R⁴, R⁶, R⁷, R⁸, R⁹, R¹¹, R¹², R¹³, R¹⁴, R¹⁶, R¹⁷, R¹⁸ and R¹⁹ may be H or a substituent selected from the group consisting of —OR⁴¹, —OR⁴², —SR⁴¹—SR⁴², —NR⁴¹R⁴⁵, and —NR⁴²R⁴⁵;
R⁵, R¹⁰, and R¹⁵ are the same or different at each occurrence and may be selected from R⁴¹ and R⁴²;
with
R⁴¹ being C₁-C₂₀ cyclic or acyclic straight or branched chain alkyl, optionally interrupted one or more times with —O—, —OC(═O)—, —C(═O)O—, —S—, secondary nitrogen, tertiary nitrogen, quaternary nitrogen, —CR⁴⁵═CR⁴⁶—, —C≡C—, —C(═O)—, —C(═O)NR⁴⁵—, —NR⁴⁵C(═O)—, —S(═O)—, —S(═O)₂—, or —X⁶—, and/or substituted one or more times with R⁴², R⁵⁷, or R⁵⁸;
R⁴² being C₅-C₃₀ aryl in which, optionally, one or more of the aromatic carbon atoms are replaced with N, O or S, and, optionally, one or more of the aromatic carbon atoms carry a group R⁴¹, R⁵⁷, or R⁵⁸;
R⁵⁷ being —CN, —CF₃, —CSN, —NH₂, —NO₂, —NCO, —NCS, —OH, —F, —PO₂, —PH₂, —SH, —Cl, —Br,
or —I;
R⁵⁸ being —C(═O)R⁴⁵, —C(═O)OR⁴⁵, —C(═O)NR⁴⁵R⁴⁶, —NHR⁴⁵, —NR⁴⁵R⁴⁶, —N⁽⁺⁾R⁴⁵R⁴⁶R⁴⁷, —NC(═O)R⁴⁵, —OR⁴⁵, —OC(═O)R⁴⁵, —SR⁴⁵, —S(═O)R⁴⁵, or —S(═O)₂R⁴⁵;
R⁴⁵, R⁴⁶, and R⁴⁷ being, the same or different at each occurrence, H, R⁴¹, or R⁴²;
X⁶ being C₄-C₃₀ arylene in which, optionally, one or more of the aromatic carbon atoms are replaced with N, O, or S, and, optionally, one or more of the aromatic carbon atoms carry a group R⁴¹, R⁵⁷, or R⁵⁸;
wherein
when x is zero, y is zero, and n≧1:
at least one of [R³, R⁴, R¹⁶, and R¹⁷] and at least one of [R¹⁶, R¹⁷, R¹⁸, and R¹⁹] is one of said substituents;
when x is zero, y is 1, and n is zero:
at least one of [R³, R⁴, R¹¹, and R¹²] is one of said substituents;
when x is zero, y is 1, and n≧1:
at least one of [R³, R⁴, R¹¹, and R¹²] and at least one of [R¹³, R⁴, R⁶, and R¹⁷] and at least one of [R¹⁶, R¹⁷, R⁸, and R¹⁹] is one of said substituents;
when x is 1, y is zero, and n is zero:
at least one of [R³, R⁴, R⁶, and R⁷] is one of said substituents;
when x is 1, y is zero, and n≧1:
at least one of [R³, R⁴, R¹¹, and R¹²] and at least one of [R⁸, R⁹, R¹⁶, and R¹⁷] and at least one of [R¹⁶, R¹⁷, R¹⁸, and R¹⁹] is one of said substituents;
when x is 1, y is 1, and n is zero:
at least one of [R³, R⁴, R⁶, and R⁷] and at least one of [R⁸, R⁹, R¹¹, and R¹²] is one of said substituents; and
when x is 1, y is 1, and n≧1:
at least one of [R³, R⁴, R⁶, and R⁷] and at least one of [R⁸, R⁹, R¹¹, and R¹²] and at least one of [R³, R¹⁴, R¹⁶, and R¹⁷] and at least one of [R¹⁶, R¹⁷, R¹⁸, and R¹⁹] is one of said substituents.

2. A polymeric carbazole compound according to claim 1,
wherein
when x is zero, y is zero, and n≧1:
at least one of [R³, R⁴], and at least one of [R¹⁶, R¹⁷] is one of said substituents;
when x is zero, y is 1, and n is zero:
at least one of [R³, R⁴], and at least one of [R¹¹, R¹²] is one of said substituents;
when x is zero, y is 1, and n≧1:
at least one of [R³, R⁴], and at least one of [R¹¹, R¹²], and at least one of [R¹³, R¹⁴], and at least one of [R¹⁶, R¹⁷] is one of said substituents;
when x is 1, y is zero, and n is zero:
at least one of [R³, R⁴], and at least one of [R⁶, R⁷] is one of said substituents;
when x is 1, y is zero, and n≧1:
at least one of [R³, R⁴], and at least one of [R⁶, R⁷], and at least one of [R¹⁶, R¹⁷], and at least one of [R¹⁸, R¹⁹] is one of said substituents;
when x is 1, y is 1, and n is zero:
at least one of [R³, R⁴], and at least one of [R¹¹, R¹²], and at least one of [R⁶, R⁷, R⁸, R⁹] is one of said substituents; and
when x is 1, y is 1, and n≧1:
at least one of [R³, R⁴], and at least one of [R⁶, R⁷], and at least one of [R⁸, R⁹], and at least one of [R¹, R²], and at least one of [R¹³, R¹⁴], and at least one of [R⁶, R⁷] is one of said substituents.

3. A polymeric carbazole compound according to claim 1, wherein x is 1; y is zero; n is 1, each of R¹, R², R³, R⁷, R⁸, R⁹, R⁷, and R¹⁹ is H, each of R⁴, R⁶, R¹⁶ and R¹⁸ is
—OR⁴¹, and each of R⁵ and R¹⁰ is R⁴¹.

4. A polymeric carbazole compound according to claim 1, wherein x is 1; y is 1; n is zero; each of R², R³, R⁶, R⁷, R⁸, R¹², R³, R⁴ is H; each of R¹, R⁴, R⁹, R¹¹, is —OR⁴¹, and each of R⁵, R¹⁰ and R¹⁵ is R⁴¹.

5. A polymeric carbazole compound according to claim 1, wherein x is 1; y is 1; n is zero; each of R¹, R², R³, R⁷, R⁸, R⁹, R¹², R¹³, is H; each of R⁴, R⁶, R¹¹, and R¹⁴ is —OR⁴¹, and each of R⁵, R¹⁰ and R¹⁵ is R⁴¹.

6. A polymeric carbazole compound according to any one of the preceding claims, wherein —OR⁴¹ is methoxy (—OCH₃, MeO).

7. A polymeric carbazole compound according to any one of the claims 1 to 5, wherein —OR⁴¹ is a straight or branched alkoxy chain of formula —OC₁₀H₂₁.

8. A polymeric carbazole compound according to claim 7, wherein said straight or branched alkoxy chain of formula —OC₁₀H₂₁ is 3,7-dimethyloctyloxy.

9. A polymeric carbazole compound according to claim 1, wherein R⁴¹ is a straight or branched alkyl chain of formula —C₁₀H₂₁.

10. A polymeric carbazole compound according to claim 9, wherein said straight or branched alkyl chain of formula C₁₀H₂₁ is 3,7-dimethyloctyl.

11. A semiconducting material comprising a polymeric carbazole compound according to claim 1.

12. An electro luminescent device comprising a semiconducting material according to claim 11.

13. An electro luminescent device according to claim 12, wherein said semiconducting material is combined with a luminescent emitter.

14. A process for the preparation of a polymeric carbazole compound according to claim 1.

15. Use of a polymeric carbazole compound according to claim 1 as a semiconducting material.

16. Use of a polymeric carbazole compound according claim 1 as a host matrix for luminescent emitters.
